(19) United States
(12) Patent Application Publication
(10) Pub. No.: US 2015/0277711 A1
(43) Pub. Date: Oct. 1, 2015

(54) USER INTERACTION AND MOTION DRIVING UPDATES TO COMPONENTS IN AN IMMERSIVE DOCUMENT VIEW

(71) Applicant: Microsoft Corporation, Redmond, WA (US)

(72) Inventors: Joseph Masterson, Maple Valley, WA (US); Jeremy de Souza, Bellevue, WA (US); Kenneth Fern, Bellevue, WA (US); Jin Ma, Redmond, WA (US); Elena Catrinescu, Woodinville, WA (US); Nathan Waddoups, Redmond, WA (US); David Paul Limont, Seattle, WA (US); David Lloyd Meyers, JR., Seattle, WA (US); Hayley Lynn Steplyk, Redmond, WA (US)

(73) Assignee: MICROSOFT CORPORATION, Redmond, WA (US)

(21) Appl. No.: 14/497,254

(22) Filed: Sep. 25, 2014

Related U.S. Application Data
(60) Provisional application No. 61/973,082, filed on Mar. 31, 2014.

(51) Int. Cl. G06F 3/0484; H04L 12/58; G06T 13/80; G06F 3/0481; G06F 3/0482

(52) U.S. Cl. CPC G06F 3/04842; G06F 3/0481; G06F 3/0482; G06F 3/04817; G06T 13/80; H04L 51/04; G06T 2200/24

(57) ABSTRACT

User interaction with components and content items provided in an immersive information and document view is provided. When a user receives an electronic communication, for example, an electronic mail item having an attached content item, the content item may be selectively displayed in an immersive view pane displayed in an electronic communications user interface. The immersive view pane may be animated into display for effect. If two or more attachments are received, the attachments may be displayed in an attachment well. Display of various attached content items may be provided via a number of navigation methods.

### CROSS-REFERENCE TO RELATED APPLICATIONS

This application claims the benefit of U.S. Provisional Patent Application No. 61/973,082, filed Mar. 31, 2014.

### BACKGROUND

Computer and computer software users have become accustomed to generating, editing, receiving and sending many types of content items, for example, documents of different types, photographs, images, electronic mail items, calendaring items, notes items, and the like. In a typical electronic mail setting, a user often attaches a document or other content item (hereafter referred to as “attachment” or “content item”) to an electronic mail item he/she then sends to a receiving user for review or editing. The receiving user then typically downloads the received attachment to his/her local computing device or to an enterprise (local or remote) storage repository, for example, a company or school file server or a remote server at which the receiving user has a storage location or at a collaborative file storage location at which the sending user and the receiving user store content items for receiving and editing as part of a collaborative work group of any of a number of types.

In a typical user interface for any electronic communications application, for example, an electronic mail user interface, a variety of information panes or canvases may be provided in which different types of information or content is displayed to a user. For example, one pane may include a listing of folders, contacts information, and the like, a second pane may include a listing of electronic communications (e.g., emails) received, sent, forwarded, reviewed, not reviewed, and the like by a user. Another pane may include a communications pane in which selected electronic communications items may be viewed by the user including the viewing of a communications thread or string of associated emails or other communications items. In addition, other components of such a user interface may include calendaring components, tasks components, notes components, etc. In addition, for any given electronic communication item provided in such a user interface, one or more attachments, such as attached documents, images, and the like, may be provided such that selection of any of one or more of the attachments may cause a launching of a secondary user interface for displaying a content item associated with the selected attachment.

Having such an array of information and selectable content in a given user interface is often problematic for users because navigation of the user interface including review of individual items and selection of attachments for review and/or editing can become overwhelming and inefficient. Thus, there is a need for improved user interaction with components and content items provided in an immersive information and document view. It is with respect to these and other considerations that the present invention has been made.

### SUMMARY

This summary is provided to introduce a selection of concepts in a simplified form that are further described below in the detailed description. This summary is not intended to identify key features or essential features of the claimed subject matter, nor is it intended as an aid in determining the scope of the claimed subject matter.

Embodiments of the present invention solve the above and other problems by providing improved user interaction with components and content items provided in an immersive information and document view. According to embodiments, when a user launches a user interface provided by a software application, for example, an electronic mail application, having a number of user interface components in which various information, selectable items, and attachments may be provided, an improved navigation of the user interface is provided.

According to one embodiment, selection of an item in one portion, or user interface component may cause a display of the selected portion in an immersive view pane, and the display of the immersive view pane may be provided through a pleasing animation that causes the selected content item or user interface component to slide into view in front of the user such that the user fully appreciates what aspect, content item or component is being provided in the immersive view.

According to other embodiments, an improved navigation of received attachments may be provided. An attachment well may be provided in which selectable icons for attached content items (e.g., content items attached to an electronic mail item) may be displayed. Selection of one of the received attachments may cause a display of the associated content item in an adjacently disposed immersive view pane or canvas, as described above. If the user selects a another attachment contained in the attachment well, the displayed content item in the immersive view pane will immediately be replaced with a display of a content item associated with the selected attachment.

A pair of navigation elements, for example, navigation arrows, may be displayed on each side of a displayed content item in the immersive view pane for allowing a user to navigate through various displays of attached content items. According to another embodiment, a swiping motion utilizing a finger or stylus or other touch means on a touch-enabled display surface over a linearly-arranged collection of attachment icons may cause an automatic display of content items associated with a touched icon in the immersive view pane as each successive icon is touched. According to another embodiment, a “film strip” view navigation ribbon may be provided in proximity to the immersive view pane in which may be disposed selectable icons for each received attachment. Selection of the icons in the film strip view ribbon by individual selection or by swipe or other similar contact may cause a display of content items associated with each selected attachment icon.

The details of one or more embodiments are set forth in the accompanying drawings and description below. Other features and advantages will be apparent from a reading of the following detailed description and a review of the associated drawings. It is to be understood that the following detailed description is explanatory only and is not restrictive of the invention as claimed.

### DESCRIPTION OF THE DRAWINGS

FIG. 1 is simplified block diagram illustrating a system for electronic communication-based storage and use of documents and other content items to support multiple workflows.

FIG. 2A illustrates a computer-generated user interface for an example electronic mail user interface showing navigation between components of the user interface.

FIG. 2B illustrates a computer-generated user interface for an example electronic mail user interface showing navigation between components of the user interface and illustrates navigation of a content item associated with a selected attachment into an immersive view pane.

FIG. 2C illustrates a computer-generated user interface of an electronic mail application with an immersive view pane in which a received content item may be displayed for viewing.

FIG. 2D illustrates a computer-generated user interface of an electronic mail application with an immersive view pane and showing a display of software application functionality for allowing editing of a received content item.

FIG. 2E illustrates a computer-generated display of an electronic mail user interface and showing a navigation of a plurality of attachments received in an attachment well for displaying content items associated with selected attachments.

FIG. 2F illustrates a computer-generated display of an electronic mail user interface and showing a navigation of a plurality of attachments received in an attachment well for displaying content items associated with selected attachments.

FIG. 2G illustrates a computer-generated display of an electronic mail user interface and showing a navigation of a plurality of attachments received in an attachment well for displaying content items associated with selected attachments.

FIG. 2H illustrates a computer-generated display of an electronic mail user interface and showing a navigation of a plurality of attachments received in an attachment well for displaying content items associated with selected attachments.

FIG. 2I illustrates a computer-generated display of an electronic mail user interface and showing a navigation of a plurality of attachments received in an attachment well for displaying content items associated with selected attachments.

FIG. 2J illustrates a computer-generated user interface for an example electronic mail user interface showing navigation between components of the user interface and illustrates an attachment well containing a plurality of attached content items in an electronic mail item.

FIG. 3 is a flowchart illustrating a method for providing improved user interaction with components and content items provided in an immersive information and document view.

FIG. 4 is a block diagram illustrating example physical components of a computing device with which embodiments of the invention may be practiced.

FIGS. 5A and 5B are simplified block diagrams of a mobile computing device with which embodiments of the present invention may be practiced.

FIG. 6 is a simplified block diagram of a distributed computing system in which embodiments of the present invention may be practiced.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention, but instead, the proper scope of the invention is defined by the appended claims.

Embodiments of the present invention solve the above and other problems by providing improved user interaction with components and content items provided in an immersive information and document view. According to embodiments, when a user launches a user interface provided by a software application, for example, an electronic mail application, having a number of user interface components in which various information, selectable items, and attachments may be provided, an improved navigation of the user interface is provided. According to one embodiment, selection of an item in one portion, or user interface component may cause a display of the selected portion in an immersive view pane. The display of the immersive view pane may be provided through a pleasing animation that causes the selected content item or user interface component to slide into view in front of the user such that the user fully appreciates what aspect, content item or component is being provided in the immersive view.

In an electronic communications view pane or canvas, an attachment well may be provided for displaying selectable icons for attached content items (e.g., content items attached to an electronic mail item). Selection of one of the attachment icons causes a display of the associated content item in an immersive view pane or canvas to allow a user to review the displayed content item in side-by-side or top-bottom orientation relative to the electronic communications view pane or canvas. Thus, a user may, for example, view a content item attached to an electronic mail item in an immersive view pane on a left side of a computer-generated display and simultaneously view an electronic mail conversation in which the content item was attached displayed in an electronic communications view pane or canvas on the right side of the computer-generated display. That is, both the immersive view display pane and the electronic communications pane may be displayed adjacent to each other in the electronic communications user interface allowing the user to view his/her electronic mail items and a selected content item simultaneously.

If the user decides to edit a displayed content item, an edit function may be selected, and functionality associated with a document type of the content item, for example, word processing functionality may be provided in the immersive view pane to allow the user to edit the displayed content item according to a desired functionality. According to one embodiment, initiation of an editing function on a displayed content item also causes an automatic generation of a corresponding electronic communication with which the edited content item may be communicated to one or more desired recipients.

According to other embodiments, an improved navigation of received attachments may be provided. If a user receives an electronic communication, for example, an electronic mail item having a plurality of attached content items, the plurality of attached content items, for example, a word processing document, a spreadsheet document, a photograph, an image file, a video file, and the like, may be displayed in an attachment well in the received electronic mail item. Selection of one of the received attachments may cause a display of the associated content item in an adjacently disposed immersive view pane or canvas, as described above. According to one embodiment, if the user selects a another attachment contained in the attachment well, the displayed content item in the immersive view pane will immediately be replaced with a display of a content item associated with the selected attachment. Thus, the user may conduct a visual navigation of the attachments received with the electronic communication and displayed in the attachment well of the electronic communication pane or canvas by selecting different attachments followed by a display of the content items associated with the selected attachments.

A pair of navigation elements, for example, navigation arrows may be displayed on each side of a displayed content item in the immersive view pane when more than one attachment has been received. According to this embodiment, if a user selects one of the attachments, the associated content item will be displayed in the immersive view pane. Then, if the user selects one of the pair of navigation control elements, for example, selection of a right-directional arrow, then the next attachment in succession will be automatically selected, and the associated content item will be displayed in the immersive view pane replacing the display of the previously selected content item. Thus, by selecting the right directional arrow, the user may navigate through received attachments in a left-to-right orientation where each successive selection of the navigation element causes a display of the next in line attachment content item. As should be understood, selection of the other of the pair of navigation elements (i.e., selection of the left directional arrow) may cause a navigation through the received attachments in the attachment well in a right-to-left manner where each selection of the left navigation element may cause a display of the next in line to the left content item for the next in line attachment.

According to another embodiment, a swiping motion utilizing a finger or stylus or other touch means on a touch-enabled display surface over a linearly-arranged collection of attachment icons may cause an automatic display of content items associated with a touched icon in the immersive view pane as each successive icon is touched. According to another embodiment, a “film strip” view navigation ribbon may be provided in proximity to the immersive view pane in which may be disposed selectable icons for each received attachment. Selection of the icons in the film strip view ribbon may be performed by individual selection, or by swipe or other similar contact with each selected attachment icon.

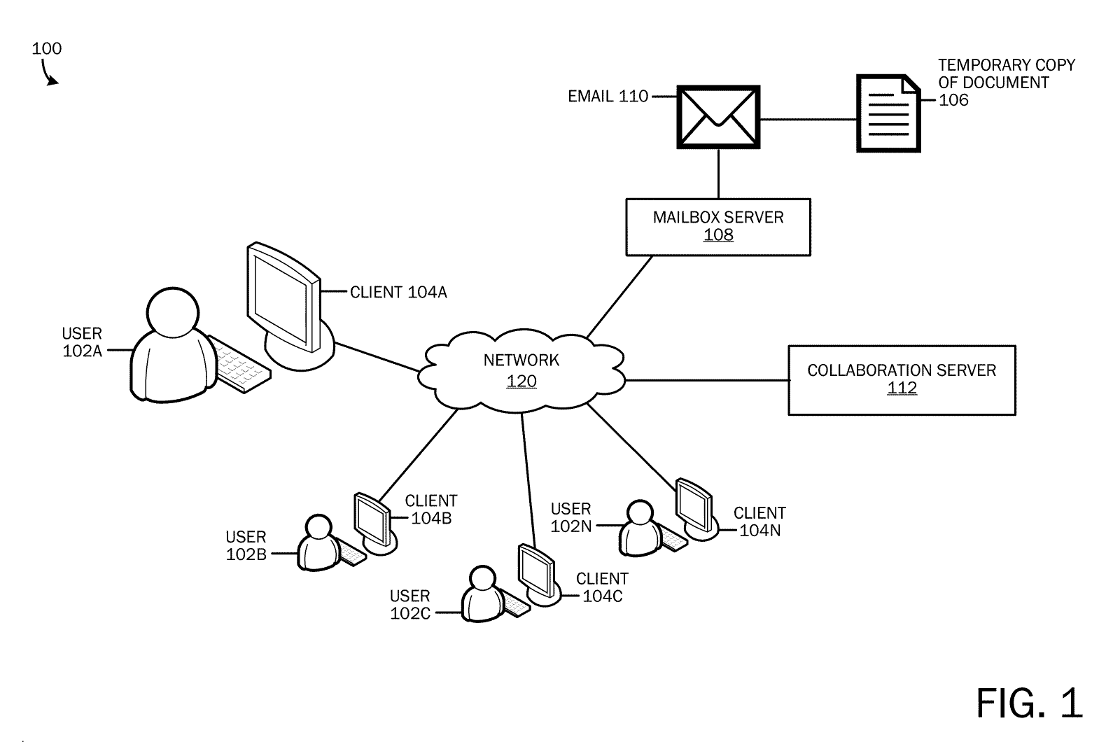

FIG. 1 is simplified block diagram illustrating a system 100 for electronic communication-based storage and use of documents and other content items to support multiple workflows. As illustrated in FIG. 1, a variety of users 102a, 102b, 102c, 102n are illustrated in association with respective client devices 104a, 104b, 104c, 104n. The users and the associated client devices are illustrative of one or more users who may generate, edit, receive, send, or otherwise interact with content items of various types as described herein. The client devices 104a-104n are illustrative of a variety of computing devices, for example, desktop computing devises, laptop computing devices, tablet computing devices, handheld computing devices (mobile phones), and the like. Each of the example computing devices may be interacted with according to a variety of input means, for example, keyboard input, mouse input, electronic pen and ink input, touch input, gesture input, voice input, eye tracking input, and the like. At each of the client devices 104a-104n, a variety of software applications may be provided for allowing the one or more users to interact with a variety of content items. For example, software applications such as electronic mail applications, word processing applications, slide presentation applications, spreadsheet applications, notes taking applications, desktop publishing applications, calendaring applications, image processing and editing applications, and the like may be operated at the client devices by the one or more users 102a-102n. The network 120 is illustrative of an enterprise-based network, for example, an intranet, or a distributed computing network, for example, the Intranet, over which the various users may communicate with each other and with other computing systems, as described herein.

The mailbox server 108 is illustrative of an electronic communication system that may be located local to one of the various users, or that may be located remotely from the various users for allowing electronic mail and other electronic communications between the various users. An example of a server 108 may be an EXCHANGE server from Microsoft Corporation. The electronic communication item 110 (e.g., email item) is illustrative of an electronic communication that may be communicated between one or more users for passing text-based communications, and a variety of attached files, for example, audio files, text files, image files, data files, and the like. The temporary copy of a document 106 is illustrative of a temporary storage of an edited attached content item that is edited in association with an electronic communication item and that is temporarily stored with an electronic communication at the electronic mail server 108 for disposition according to embodiments of the present invention. The collaboration server 112 is illustrative of a local or remote storage repository at which one or more content items may be stored. For example, the collaboration server 112 may be a shared resources server located at an enterprise accessible by the various users, or may be remotely located from the various users at which the various users may store and collaborate on various documents. An example of such a collaboration server 112 may include a SHAREPOINT server or ONEDRIVE server from Microsoft Corporation.

According to embodiments of the present invention, when an attached content item is received and edited by a given user, a temporary copy 106 of the edited content item is stored with the received electronic communication item 110 at the electronic communication server 108. The content item is only stored at the collaboration server 112 if a given user desires to store the received content item apart from the electronic communication server 108 as described with respect to embodiments illustrated and described herein.

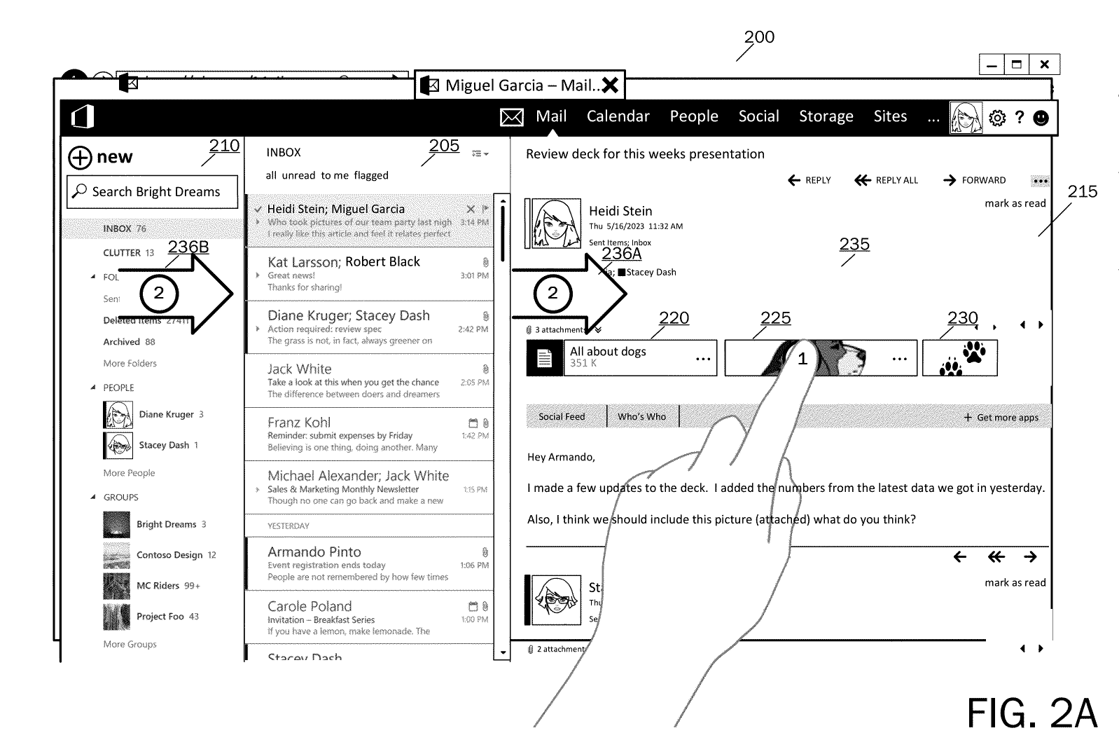

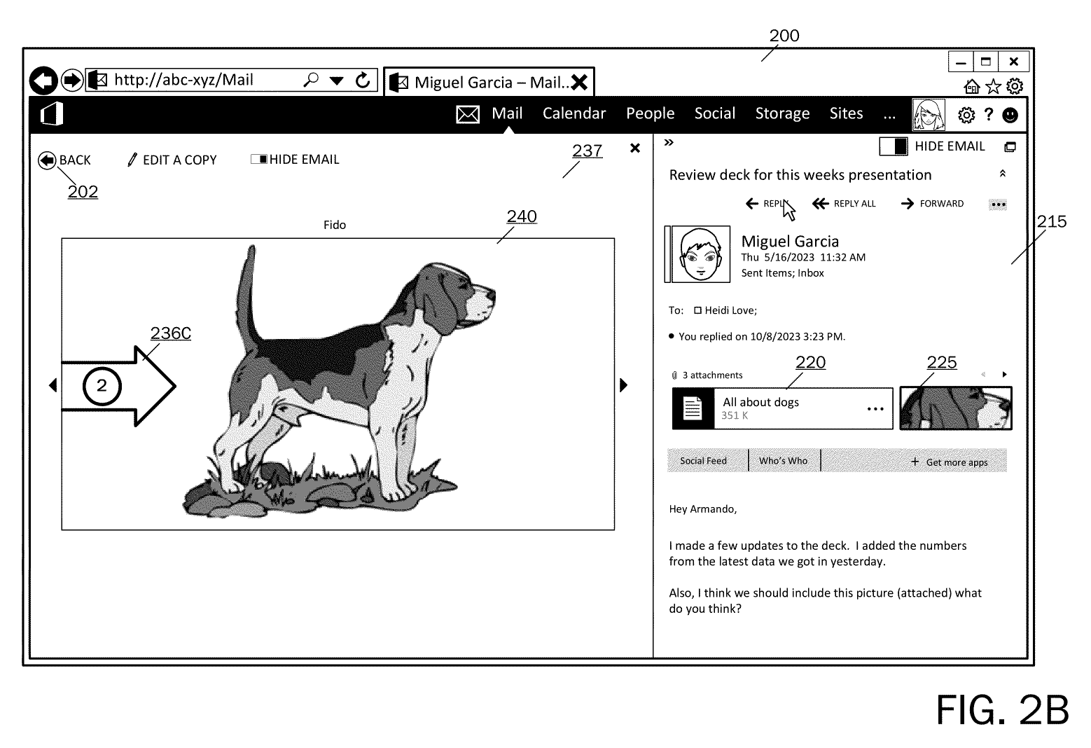

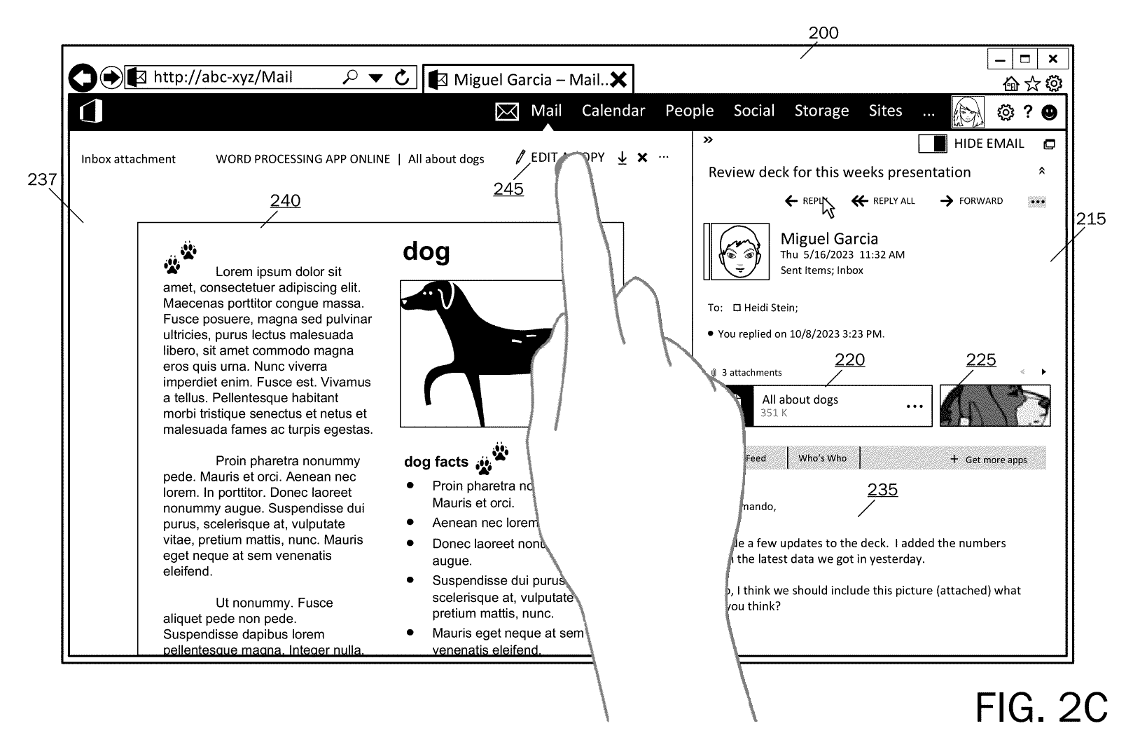

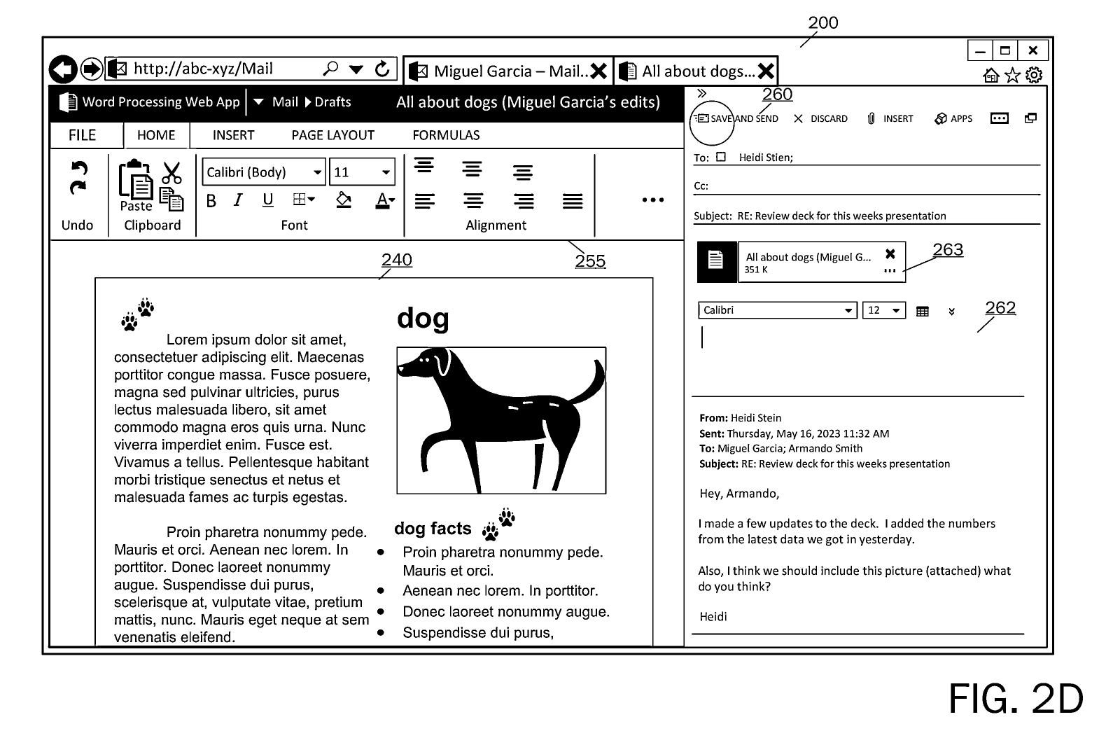

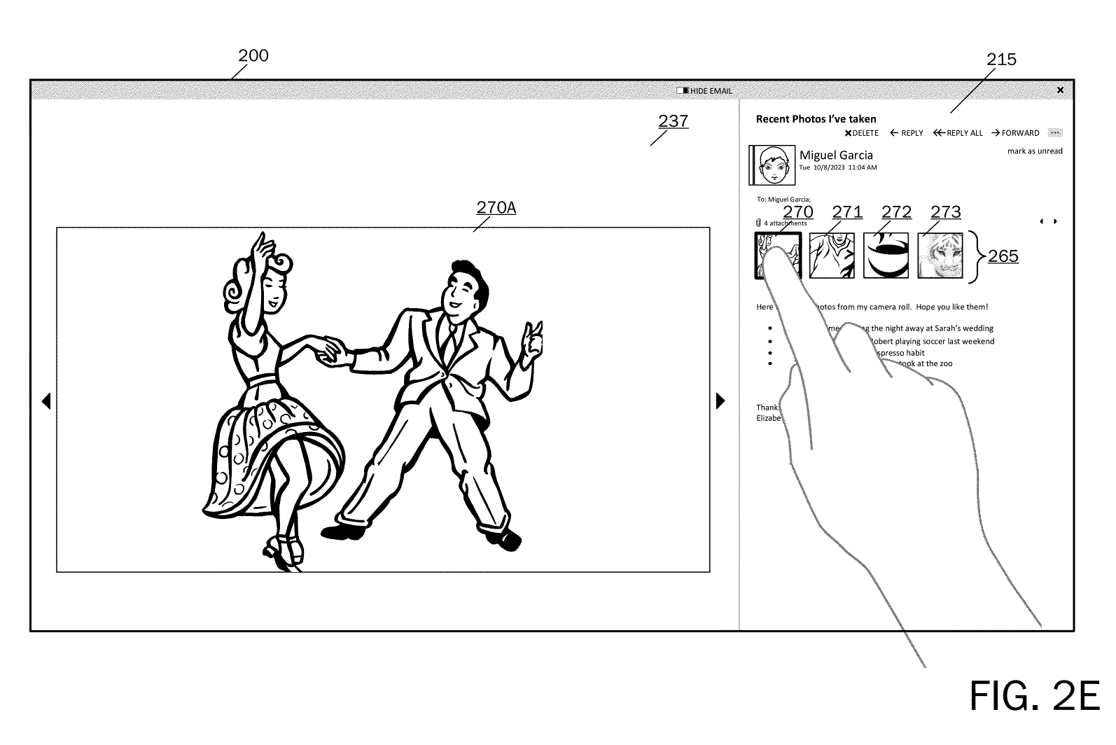

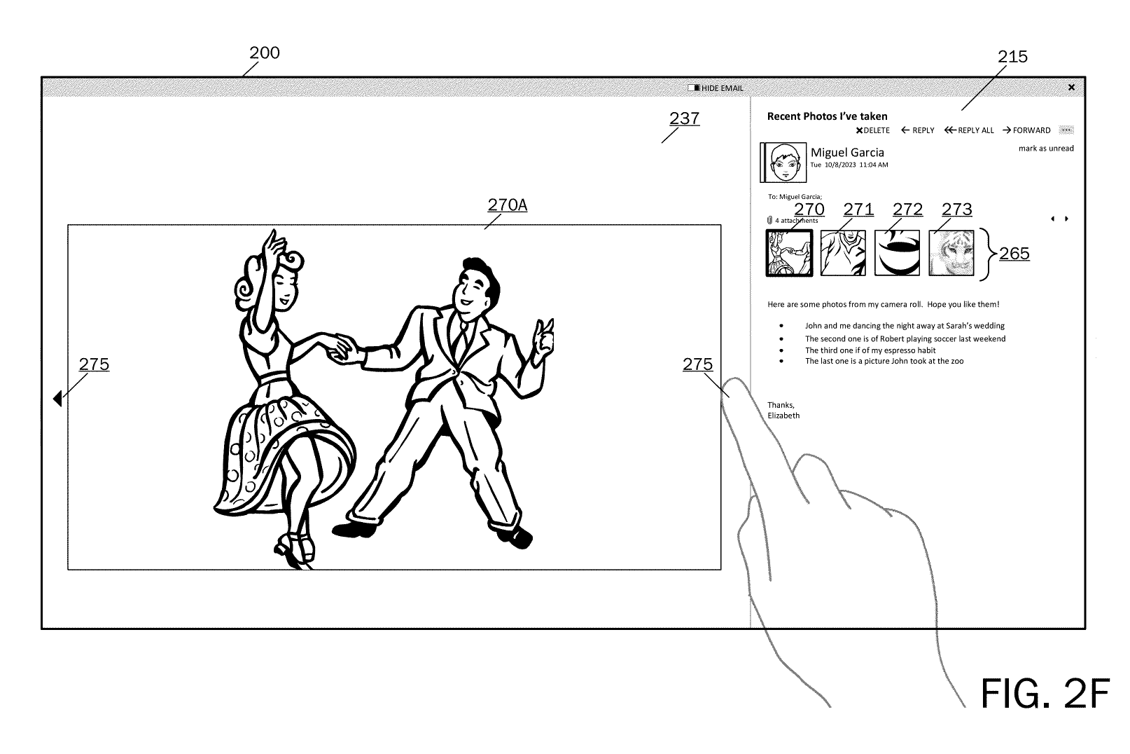

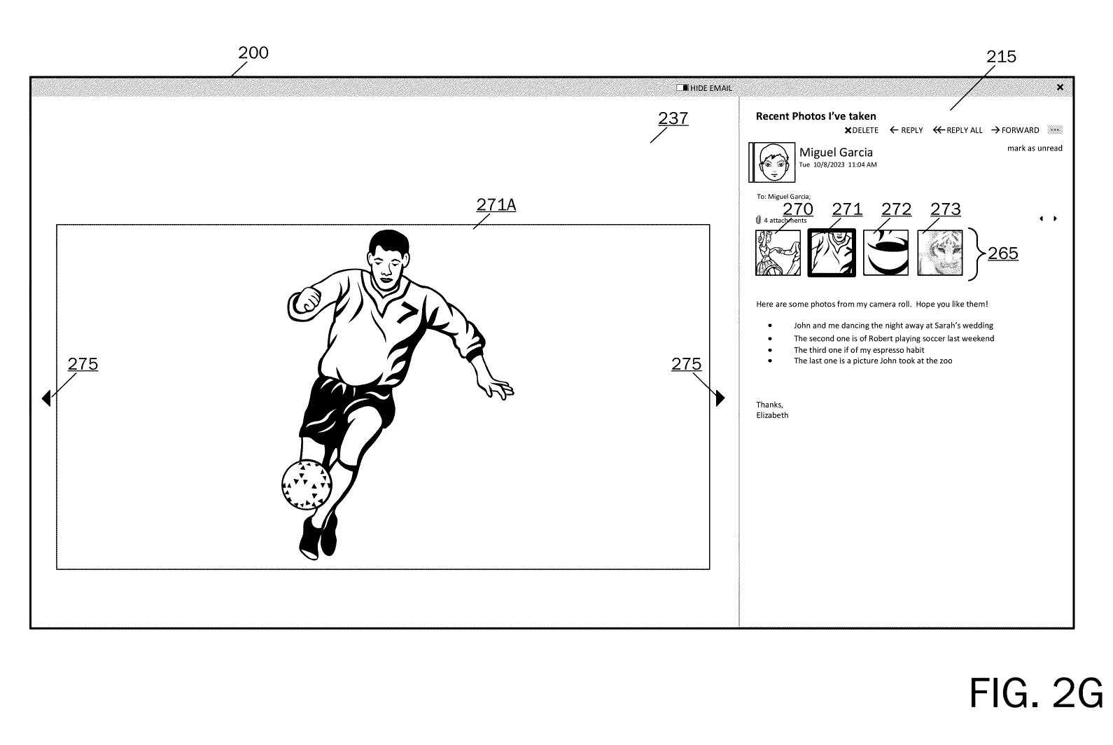

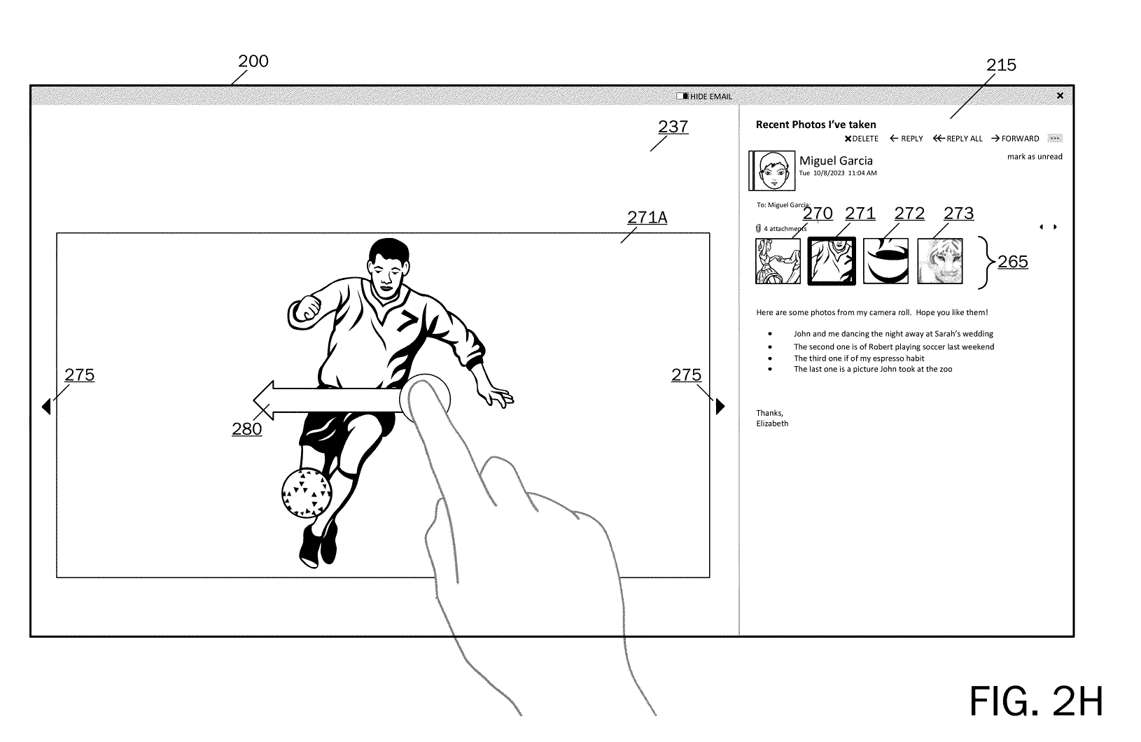

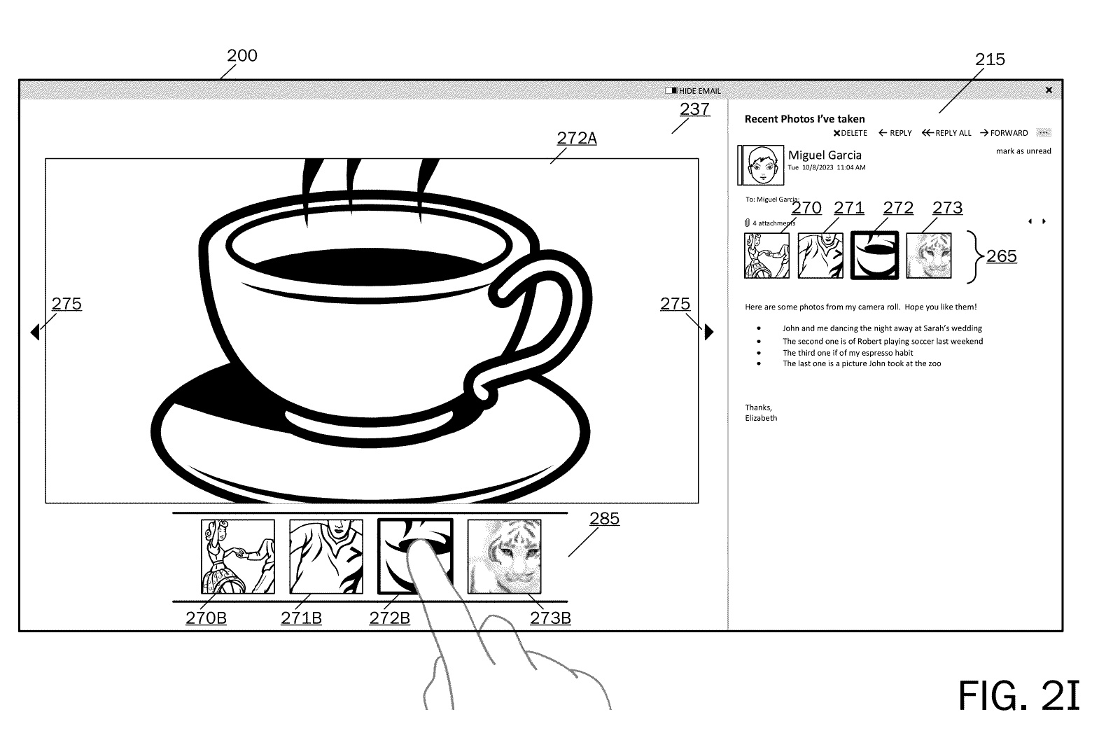

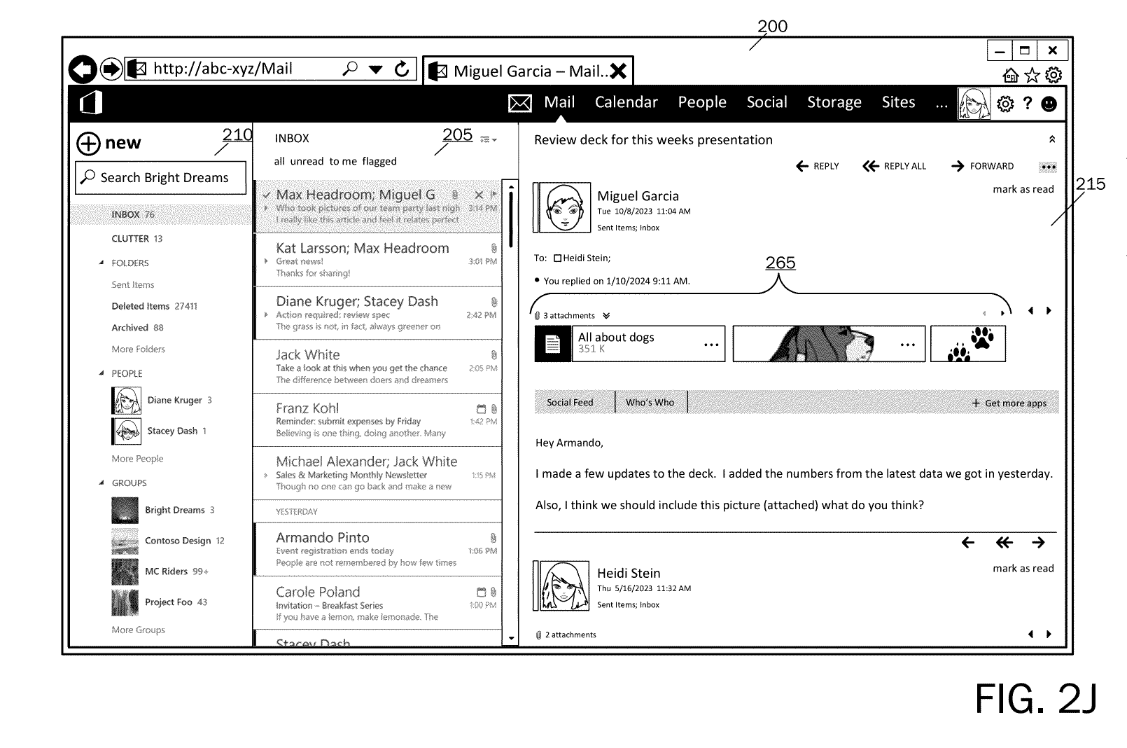

FIG. 2A illustrates a computer-generated user interface of an electronic communication application with which embodiments the present invention practiced. An example electronic communication application suitable for embodiments described herein includes OUTLOOK from Microsoft Corporation. As illustrated in FIG. 2A, a user interface 200 for an example electronic mail application with which a user may send and receive a variety of electronic messages, and with which a user may send and receive content item attachments according to embodiments of the present invention is illustrated. An electronic mail folder pane 210 is illustrated on the left side of the user interface 200 in which a variety of folders, contact items, group items, calendar items, and the like, may be provided to allow a user to select various folders, contacts, or other items associated with her electronic communication application functionality. An electronic communication items folder 205 is illustrated in which a variety of electronic communication items received by the receiving user are displayed that may be selectively reviewed and responded to according to the functionality of the associated electronic communication application. For example, the pane 205 may include an inbox for listing all received electronic mail items, a sent box for listing sent electronic mail items and/or the contents of a given folder of electronic communication items.

On the right side of the example user interface 200 is displayed an electronic communications viewing pane 215 in which a given electronic communication message or electronic communication conversation thread of items may be displayed for allowing a user to read or otherwise interact with a given electronic communication message, for example, replying to the message, forwarding the message, and the like. That is, upon selection of a given communication item (e.g., an electronic mail item) listed in an inbox displayed in the pane 205, the selected item may be opened in the pane 215 to allow the user to read or respond to the communication item. If the selected communication item contains a thread of multiple communication items comprising a communication conversation, then the entire thread of items may be displayed in the pane 215 to allow the user to navigate through the various items in the thread.

As illustrated in FIG. 2A, an example electronic mail message 235 has been received by the receiving user and has been opened in the electronic communications pane or canvas 215. The received electronic mail message includes three example attachments 220, 225, 230. As should be appreciated, the attachments 220, 225, 230 are illustrative of any attached content item, for example, a word processing document, a spreadsheet document, a slide presentation document, a notes document, an image file, a photograph, a video file and the like, that may be received by the receiving user from a sending user.

According to embodiments of the present invention, if a user selects one of the attachment icons 220, 225, 230, the content item associated with the selected attachment icon may be displayed in an immersive view pane for allowing the user to view and/or edit the selected content item, as illustrated and described below with reference to FIG. 2B. According to an embodiment, selection of one of the attachment icons, for example, the attachment icon 225, as illustrated in FIG. 2A, may cause an animation of the display of the associated content item into the immersive view pane 237, as illustrated in FIG. 2B. For example, referring to the FIG. 2A, an arrow 236A and arrow 236B are shown in FIG. 2A for purposes of illustrating an animation of the user interface 200 according to this embodiment. When the user selects an attachment icon, for example, the attachment icon 225, the electronic communication pane or canvas 215 may compress to the right to provide less space for electronic mail items, and to free up additional space to the left of the electronic mail pane or canvas 215 for display of the content item associated with the selected attachment icon 225. Simultaneously, the folder pane 210 and the electronic mail items pane 205 may be compressed to the right toward the electronic communications view pane or canvas 215 until the panes 210 and 205 disappear from view to allow the content item associated with the selected attachment icon 225 to slide into view, as illustrated in FIG. 2B.

Referring then to FIG. 2B, a content item, for example, a photograph or image of a dog associated with the selected attachment icon 225 is illustrated as having slid into view in place of the previously disposed panes 210 and 205. Also, referring to the electronic communications view pane or canvas 215, the space allowed for the pane 215 has been reduced such that now there is only room for two attachment icons 220, 225 as opposed to the previously disposed icons 220, 225, 230. The immersive view pane 237 is now disposed on the left side of the user interface 200 and the content item 240 is displayed in the immersive view pane 237. The arrow 236C illustrates a direction of the animation of the content item 240 as it is animated in sliding-in manner into the space previously occupied by the panes 210, 205.

Referring still to FIG. 2B, a back button 202 is illustrated, which when selected, may cause the immersive view pane and the included content item 240 to reverse and animate to the left out of the display making room for a re-disposition of the panes 210, 205 as illustrated in FIG. 2A. If the user selects the back button and causes the reverse animation, then the electronic communications pane or canvas 215 may be enlarged back to the original size as illustrated in FIG. 2A.

As should be appreciated, the user interface components and animation directions illustrated in FIGS. 2A and 2B are for purposes of example only, and are not limiting of other configurations that may be applied. For example, the immersive view pane may be disposed above the electronic communications view pane 215 or below the electronic communications view pane 215. Thus, an animation to bring the immersive view pane into display along with a selected content item would require a movement of the electronic communications view pane 215 to a top or bottom configuration and an animation of the immersive view pane and the selected content item into the bottom of user interface 200 or into the top of user interface 200, as required.

According to one embodiment, during the animation, described herein, the components displayed in the user interface 200 may slightly fade in or fade out for effect. For example, as the immersive view pane 237 and the associated content item are animating into position, as described above, the various components displayed in the user interface 200 or a subset of components displayed in user interface 200 may be faded in or faded out for effect. For example, as the immersive view pane 237 slides into position, the previously disposed folder pane and electronic mail items pane 210, 205 may be faded out as the immersive view pane is animated into the display position, as illustrated in FIG. 2B.

As illustrated in FIG. 2B, the immersive view pane is positioned on the left side of the user interface 200, and the electronic mail view pane 215 remains displayed on the right side of the user interface 200. As should be appreciated, the respective viewing panes may be displayed in other orientations, for example in a right/left orientation where the immersive view pane is displayed on the right side of the user interface and the electronic mail pane is displayed on the left, a top/bottom orientation where the immersive view pane is displayed on the top of the interface 200 and the electronic communication pane is displayed on the bottom of the interface 200, or a bottom/top orientation where the immersive view pane is displayed on the bottom of the interface 200 and the electronic communication view pane is displayed on a top of the interface 200. Alternatively, if the computing device in use by the receiving user is a small form device, such as a tablet computing device or mobile phone, and display space is insufficient for displaying both the immersive view pane and the electronic communication view pane, then the immersive view pane 237 may be displayed over the entire display surface of the computing device, and a functionality button or control may be provided for selectively returning the electronic communication view pane to display, as desired. Alternatively, a truncated display of the electronic communication view pane may be provided and the remaining display space may be used for the immersive view pane.

Referring now to FIG. 2C, an edit/copy function 245 is provided for allowing the user to selectively edit a content item (e.g., document) 240 displayed in the immersive view pane. That is, as will be described below, selection of the edit/copy function 245 may cause a provision of functionality associated with the document 240 to allow the user to edit the document 240 in association with the provided functionality. As should be appreciated, the edit/copy function 245 is illustrative of one of a variety of functions that may be provided in the immersive view pane for allowing a user to operate on the document displayed in the immersive view pane. For example, other functions that may be provided may include a send function for allowing the user to send the document 240 to another user, a save function for allowing a user to save the document to a storage location such as the collaboration server 112, described above, and the like.

According to embodiments of the present invention, if a user selects the edit/copy function 245, an application associated with the content item type for the content item displayed in the immersive view pane may be launched in the immersive view pane as illustrated in FIG. 2D. In FIG. 2D, word processing functionality 255 is illustrated in the immersive view pane having been provided in response to an edit function in association with a displayed word processing type document. That is, if the document 240 is a word processing application, then selection of an edit function associated with the document 240 may cause the launching and retrieval of word processing functionality for allowing a user to edit the document in association with application functionality with which the document was created. On the other hand, if the document 240 is a spreadsheet document, then selection of an edit function 245 may cause the launching of spreadsheet application functionality in the immersive view pane. Likewise, if the document 240 is a slide presentation, then selection of an edit function 245 may cause the launching and provision of slide presentation application functionality in the immersive view pane for use with the document displayed in the immersive view pane.

Referring still to FIG. 2D, an instance of a software application user interface with associated functionalities (e.g., a word processing application user interface) may be launched and displayed in the immersive view pane, or selected functionalities, for example, formatting functionalities may be provided in the immersive view pane for allowing a user to operate certain word processing functions on the document 240. Likewise, if the document 240 is another type of content item, for example a spreadsheet document, then an instance of a spreadsheet application may be launched in the immersive view pane, or certain functionalities of a spreadsheet application may be provided in the immersive view pane. As should be appreciated, if the user desires to edit a portion of the document 240 not associated with the example word processing application, for example, the photograph of a dog contained in the document 240, then functionalities required for editing an image such as the photograph of the dog may be provided to allow the user to edit the image.

Referring still to FIG. 2D, according to one embodiment, when the receiving user selects the document 240 for editing, a draft communication, for example, a draft reply electronic mail item 262 may be automatically generated and displayed in the electronic communication view pane to allow the user to communicate the edited document or other content item when the user completes the editing process. Referring to the draft communication 262, according to one embodiment, an automatic reply message to the original sender of the electronic mail message that attached the document 240 that is being edited by the receiving user may be generated so that upon completion of edits to the document 240, the editing user may select a save and send function 260 for automatically attaching the edited version of the document or content item 240 to the draft communication 262 for sending the communication to the original sending user. Thus, a communication from the sending user to the receiving user is enabled where the receiving user opens an attachment received from the sending user, edits the attachment and automatically sends the edited version of the attachment back to the original sending user without the need for saving the attachment to a hard drive or other storage repository at which edits are made and saved followed by a retrieval and re-attachment of the edited content item to a communication for transmitting to the original sending user.

Referring still to FIG. 2D, if the receiving user selects the save and send function 260, then the user interface 200 for the example electronic mail application is returned back to a state wherein the folders pane 210, the electronic communication items pane 205, and the electronic communication view pane 215, are presented, but where a reply communication 265 is illustrated with which the user may send an attachment 263 of the edited version of the originally received attachment back to the original sending user. As should be appreciated, the receiving user may enter one or more text strings such as the string “I've made some changes. Let me know what you think.”, or with which the user may attach one or more additional documents or other content items for sending to the original sending user.

FIGS. 2E-2I illustrate a number of navigation functionalities for navigating attached content items received in an electronic communication. Referring now to FIG. 2E, an immersive view pane 237 is illustrated with a content item 270A displayed in the immersive view pane. To the right of the immersive view pane an electronic communications view pane or canvas 215 is illustrated containing an electronic mail message received by the user. In the electronic mail message received by the user, an attachment well 265 is illustrated containing four attachment icons 270, 271, 272, 273. As should be appreciated, each of the attachment icons is associated with a content item attached to the email by the sender of the email.

Referring still to FIG. 2E, upon selection of one of the attachment icons 270, a corresponding content item is automatically displayed in the immersive view pane 237, as described above with reference to FIGS. 2A through 2D. According to an embodiment, when a user receives more than one attached content item, attachment icons 270, 271, 272, 273 for each received attachment may be disposed in an attachment well 265. Selection of any of the attachment icons may cause an automatic display of the associated content item in the immersive view pane 237. Thus, a user may quickly navigate through each attachment by selection the attachment icons successfully causing a successive display of the associated content items in the immersive view pane 237. For example, selection of the attachment icon 270 causes a display of the content item 270A in the immersive view pane as displayed as illustrated in FIG. 2E.

Referring now to FIG. 2F, according to another embodiment, if more than one attached content item is received in an electronic communication, a pair of navigation elements 275, for example, a pair of navigation arrows may be disposed on opposite sides of the display of the content item 270A. A user may navigate successively through attached content items by selecting one of the navigation elements. For example, selecting the navigation arrow 275 on the right side of the content item 270A may cause an immediate navigation to the next successive attachment icon 271 causing an immediate display of the associated content item in the immersive view pane as illustrated in FIG. 2G.

Referring to FIG. 2G, after a first selection of the right side navigation arrow 275, a content item 271A associated with the next successive attachment icon 271 is automatically displayed in the immersive view pane 237. As should be appreciated, selection of the left side navigation element (e.g., navigation arrow) may cause navigation to the left in the attachment well. For example, selection of the left side navigation arrow 275 would cause navigation back to the attachment icon 270 and a display of the associated content item 270A, as illustrated in FIG. 2F. As should be appreciated, even if the navigation elements 275 are disposed, manual selection of one of the other attachment icons 273, for example, will cause an immediate navigation to the content item associated with the selected attachment icon and will cause a display of the associated content item in the immersive view pane 237.

Referring to FIG. 2H, according to another embodiment, in addition to selection of one of the two navigation elements 275, a finger swipe, electronic pin swipe, mouse swipe, or the like on the displayed content item in the immersive view pane may similarly cause a navigation to the right or to the left through the available attachment icons for causing a display of the associated content items in the immersive view pane 237. For example, if the display surface containing the user interface 200 is a touch-enabled display surface, then a finger swipe to the right on this surface of the displayed content item 271A will cause a navigation to the next attachment icon 272 and will cause an immediate display of the content item associated with the attachment icon 272 in the immersive view pane 237, as illustrated in FIG. 2I. As should be appreciated, a reverse swipe 280 to the left will cause a reverse navigation back to a preceding attachment icon and will cause a corresponding display of a content item associated with a navigated to attachment icon.

Referring still to FIG. 2I, according to another embodiment, a film strip style navigation ribbon 285 may be provided in the immersive view pane 237 in proximity to a displayed content item for allowing an additional navigation means among received attachment items. As illustrated in FIG. 2I, the filmstrip style ribbon 285 contains an icon for each of the received attachment items 270B, 271B, 272B and 273B. According to an embodiment, selection of any of the attachment icons dispose in the filmstrip style ribbon will cause an immediate navigation to and display of the associated content item 272A in the immersive view pane 237, as illustrated in FIG. 2I. According to one embodiment, a finger swipe, stylus swipe, mouse curser swipe, or other user interaction with the filmstrip style ribbon 285 may allow for a right or left navigation between available attachment icons for selecting a given attachment icon from the attachment well 265 and for causing a display of an associated content item 272A in the immersive view pane 237.

Referring now to FIG. 2J, as described above, when two or more attachment content items are received in a given electronic mail item, each of the attachment content items may be represented by an attachment icon, and the plurality of the attachment icons may be disposed in an attachment well for each received electronic mail item. According to an embodiment, if a communications thread or conversation is displayed in the electronic communication view pane or canvas 215, an attachment well may be provided for each identified email sender/recipient as required. For example, if a first email sender/recipient in the communications thread received and/or sent four attachments, then an associated attachment well would contain four attachment icons. If another sender/receiver in the communications thread sent and/or received five attachments, then an attachment well would include five attachment icons.

According to an embodiment, if a given attachment well includes a number of attachment icons that exceeds the available display space in the electronic communications view pane or canvas 215 for arranging the attachment icons linearly from left to right, as illustrated in FIG. 2I, then a navigation control may be provided for navigation to additional attachment icons not presently in view in the pane 215. For example, a pair of navigation elements similar to the navigation elements 275 illustrated and described above with respect to FIG. 2G may be provided on each side of the attachment well 265 for allowing navigation to additional attachment icons. Alternatively, attachment icons may be stacked vertically in a matrix of displayed attachment icons to allow additional attachment icons to be displayed in the available display space. In addition, a swiping contact on the items displayed in the attachment well 265 may also be used to navigate to additional attachment items.

Having described a system architecture, various user interface components and various aspects of embodiments of the present invention with respect to FIGS. 1 through 2J, FIG. 3 is a flowchart illustrating a method for providing improved user interaction with components and content items provided in an immersive information and document view. The routine 300 begins at start operation 305 and proceeds to operation 310 where a user receives an electronic communication, for example, an electronic mail item, a text message, an instant message, and the like having a content item attachment contained in the electronic communication. If more than one content item attachment is included with the electronic communication, then an attachment well may be displayed in the electronic communications pane or canvas 215 for showing an attachment icon associated with each received attachment.

At operation 315, if a user selects one of the attachment icons, an associated content item may be immediately displayed in the immersive view pane 237, as illustrated and described above. At operation 320, according to one embodiment, the immersive view pane 237 may be animated into view while the electronic communications view pane or canvas shrinks if required to provide additional space for the immersive view pane and while other user interface components in the use interface 200, for example, the folder pane and the electronic mail items pane are displaced from view from the animating-in view of the immersive view pane.

At operation 325, editing of a displayed content item may be enabled. And, sending a communication attaching an edited content item may be performed, as illustrated and described above with reference to FIGS. 2C and 2D.

At operation 330, navigation of content items associated with attachment icons contained in the attachment well in enabled as illustrated and described above with reference to FIGS. 2E through 2I. For example, navigation may be provided by manual selection of one or more attachment icons contained in an attachment well, navigation may be provided by selection of a navigation element 275, for example, a navigation arrow disposed adjacent to a displayed content item, navigation may be provided by a swipe motion across the attachment well, or a swipe motion across a displayed content item, navigation may be provided by user interaction with a filmstrip style ribbon, and the like. After the user navigates through any of the received attachment items, as desired, the routine ends at operation 395.

While the invention has been described in the general context of program modules that execute in conjunction with an application program that runs on an operating system on a computer, those skilled in the art will recognize that the invention may also be implemented in combination with other program modules. Generally, program modules include routines, programs, components, data structures, and other types of structures that perform particular tasks or implement particular abstract data types.

The embodiments and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, the embodiments and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

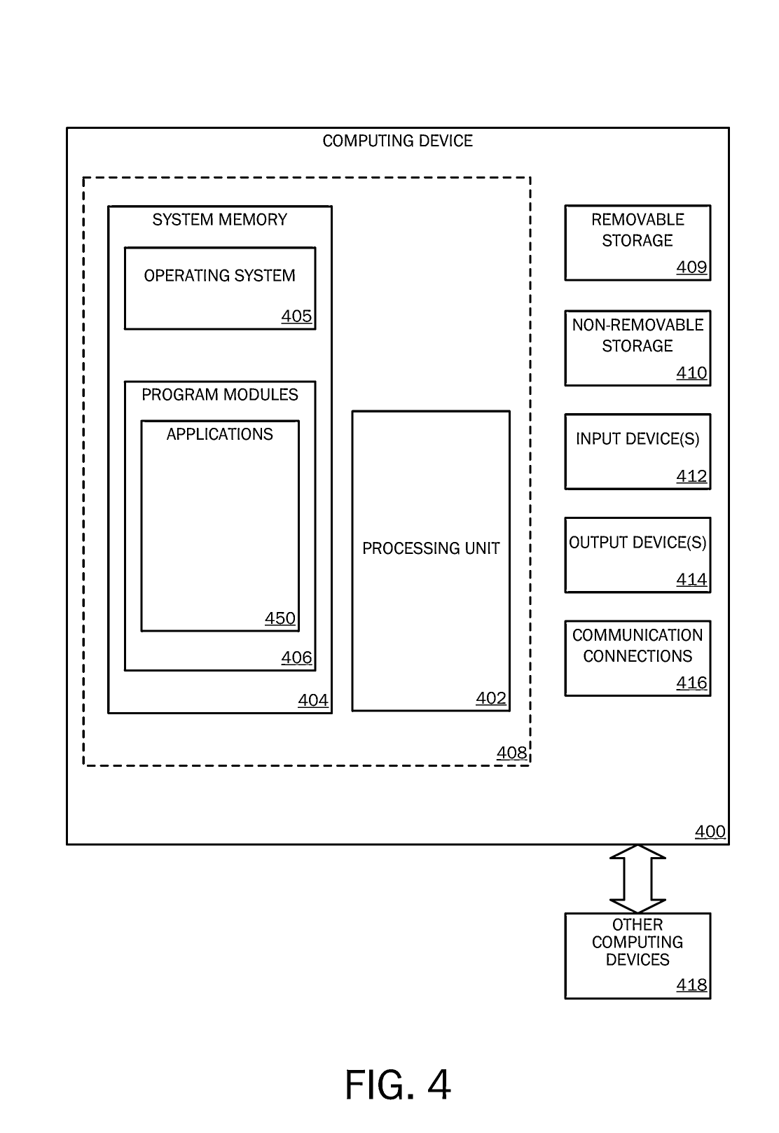

FIGS. 4-6 and the associated descriptions provide a discussion of a variety of operating environments in which embodiments of the invention may be practiced. However, the devices and systems illustrated and discussed with respect to FIGS. 4-6 are for purposes of example and illustration and are not limiting of a vast number of computing device configurations that may be utilized for practicing embodiments of the invention, described herein.

FIG. 4 is a block diagram illustrating physical components (i.e., hardware) of a computing device 400 with which embodiments of the invention may be practiced. The computing device components described below may be suitable for the client device 118 described above. In a basic configuration, the computing device 400 may include at least one processing unit 402 and a system memory 404. Depending on the configuration and type of computing device, the system memory 404 may comprise, but is not limited to, volatile storage (e.g., random access memory), non-volatile storage (e.g., read-only memory), flash memory, or any combination of such memories. The system memory 404 may include an operating system 405 and one or more program modules 406 suitable for running software applications 450. The operating system 405, for example, may be suitable for controlling the operation of the computing device 400. Furthermore, embodiments of the invention may be practiced in conjunction with a graphics library, other operating systems, or any other application program and is not limited to any particular application or system. This basic configuration is illustrated in FIG. 4 by those components within a dashed line 408. The computing device 400 may have additional features or functionality. For example, the computing device 400 may also include additional data storage devices (removable and/or non-removable) such as, for example, magnetic disks, optical disks, or tape. Such additional storage is illustrated in FIG. 4 by a removable storage device 409 and a non-removable storage device 410.

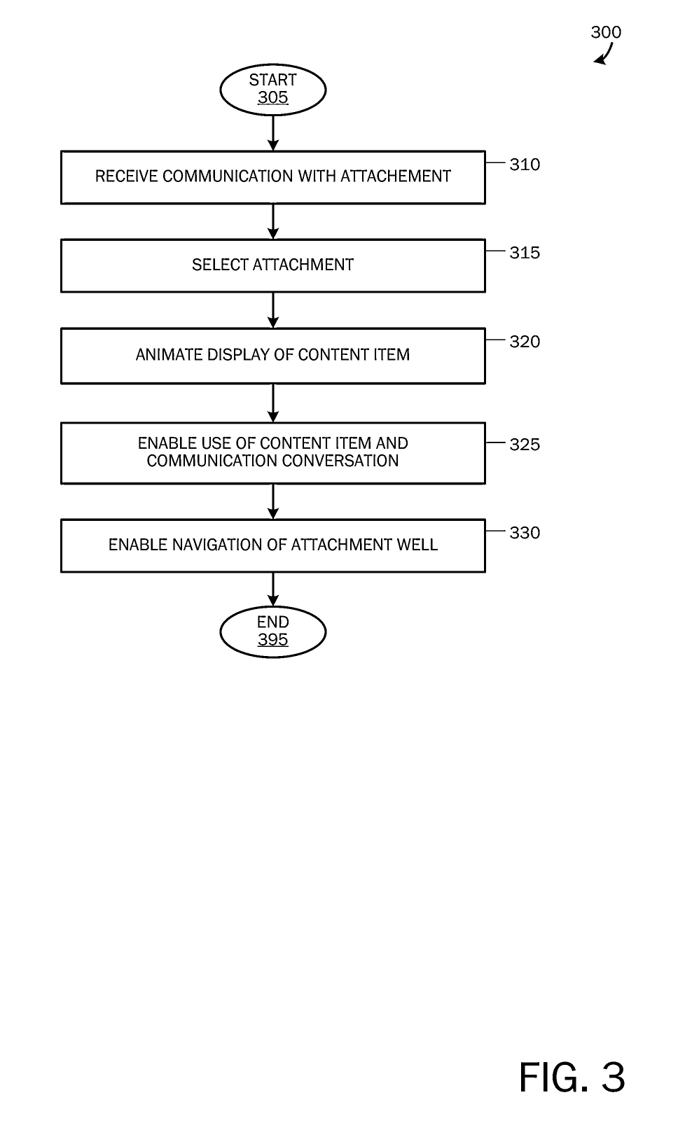

As stated above, a number of program modules and data files may be stored in the system memory 404. While executing on the processing unit 402, the program modules 406 may perform processes including, but not limited to, one or more of the stages of the method 300 illustrated in FIG. 3. Other program modules that may be used in accordance with embodiments of the present invention and may include applications such as electronic mail and contacts applications, word processing applications, spreadsheet applications, database applications, slide presentation applications, drawing or computer-aided application programs, etc.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 4 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to providing an activity stream across multiple workloads may be operated via application-specific logic integrated with other components of the computing device 400 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

The computing device 400 may also have one or more input device(s) 412 such as a keyboard, a mouse, a pen, a sound input device, a touch input device, etc. The output device(s) 414 such as a display, speakers, a printer, etc. may also be included. The aforementioned devices are examples and others may be used. The computing device 400 may include one or more communication connections 416 allowing communications with other computing devices 418. Examples of suitable communication connections 416 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 404, the removable storage device 409, and the non-removable storage device 410 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 400. Any such computer storage media may be part of the computing device 400. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

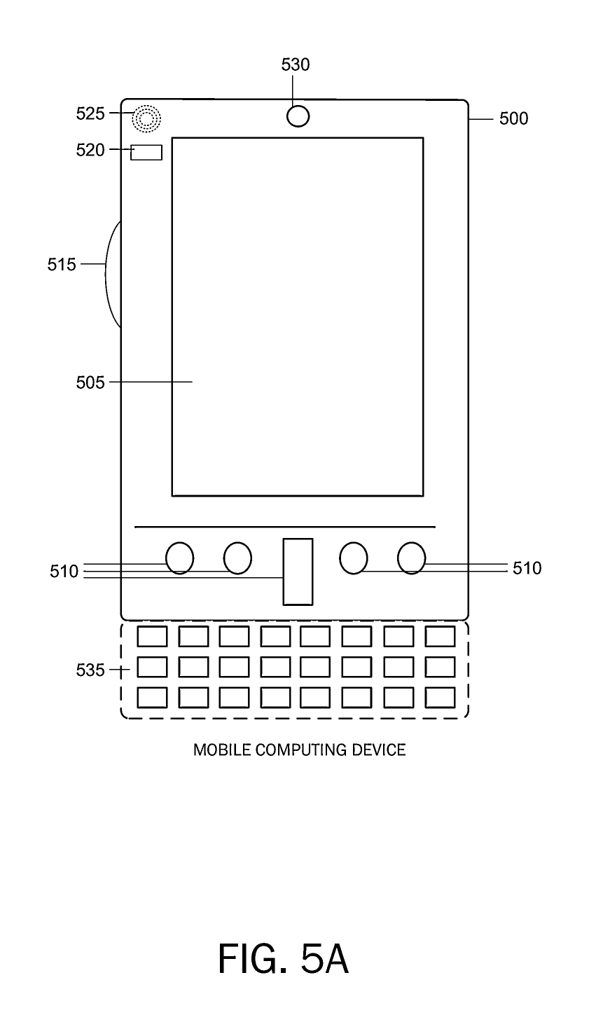

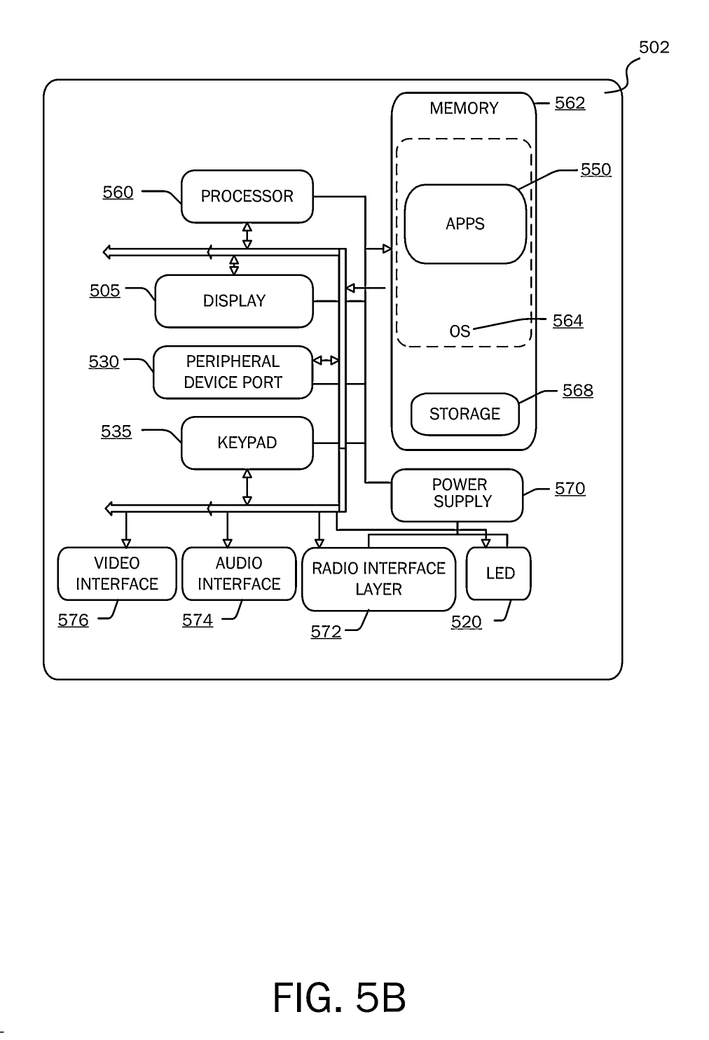

FIGS. 5A and 5B illustrate a mobile computing device 500, for example, a mobile telephone, a smart phone, a tablet personal computer, a laptop computer, and the like, with which embodiments of the invention may be practiced. With reference to FIG. 5A, one embodiment of a mobile computing device 500 for implementing the embodiments is illustrated. In a basic configuration, the mobile computing device 500 is a handheld computer having both input elements and output elements. The mobile computing device 500 typically includes a display 505 and one or more input buttons 510 that allow the user to enter information into the mobile computing device 500. The display 505 of the mobile computing device 500 may also function as an input device (e.g., a touch screen display). If included, an optional side input element 515 allows further user input. The side input element 515 may be a rotary switch, a button, or any other type of manual input element. In alternative embodiments, mobile computing device 500 may incorporate more or less input elements. For example, the display 505 may not be a touch screen in some embodiments. In yet another alternative embodiment, the mobile computing device 500 is a portable phone system, such as a cellular phone. The mobile computing device 500 may also include an optional keypad 535. Optional keypad 535 may be a physical keypad or a “soft” keypad generated on the touch screen display. In various embodiments, the output elements include the display 505 for showing a graphical user interface (GUI), a visual indicator 520 (e.g., a light emitting diode), and/or an audio transducer 525 (e.g., a speaker). In some embodiments, the mobile computing device 500 incorporates a vibration transducer for providing the user with tactile feedback. In yet another embodiment, the mobile computing device 500 incorporates input and/or output ports, such as an audio input (e.g., a microphone jack), an audio output (e.g., a headphone jack), and a video output (e.g., a HDMI port) for sending signals to or receiving signals from an external device.

FIG. 5B is a block diagram illustrating the architecture of one embodiment of a mobile computing device. That is, the mobile computing device 500 can incorporate a system (i.e., an architecture) 502 to implement some embodiments. In one embodiment, the system 502 is implemented as a “smart phone” capable of running one or more applications (e.g., browser, e-mail, calendaring, contact managers, messaging clients, games, and media clients/players). In some embodiments, the system 502 is integrated as a computing device, such as an integrated personal digital assistant (PDA) and wireless phone.

One or more application programs 550 may be loaded into the memory 562 and run on or in association with the operating system 564. Examples of the application programs include phone dialer programs, electronic communication applications, personal information management (PIM) programs, word processing programs, spreadsheet programs, Internet browser programs, messaging programs, and so forth. The system 502 also includes a non-volatile storage area 568 within the memory 562. The non-volatile storage area 568 may be used to store persistent information that should not be lost if the system 502 is powered down. The application programs 550 may use and store information in the non-volatile storage area 568, such as e-mail or other messages used by an e-mail application, and the like. A synchronization application (not shown) also resides on the system 502 and is programmed to interact with a corresponding synchronization application resident on a host computer to keep the information stored in the non-volatile storage area 568 synchronized with corresponding information stored at the host computer. As should be appreciated, other applications may be loaded into the memory 562 and run on the mobile computing device 500.

The system 502 has a power supply 570, which may be implemented as one or more batteries. The power supply 570 might further include an external power source, such as an AC adapter or a powered docking cradle that supplements or recharges the batteries.

The system 502 may also include a radio 572 that performs the function of transmitting and receiving radio frequency communications. The radio 572 facilitates wireless connectivity between the system 502 and the “outside world,” via a communications carrier or service provider. Transmissions to and from the radio 572 are conducted under control of the operating system 564. In other words, communications received by the radio 572 may be disseminated to the application programs 550 via the operating system 564, and vice versa.

The visual indicator 520 may be used to provide visual notifications and/or an audio interface 574 may be used for producing audible notifications via the audio transducer 525. In the illustrated embodiment, the visual indicator 520 is a light emitting diode (LED) and the audio transducer 525 is a speaker. These devices may be directly coupled to the power supply 570 so that when activated, they remain on for a duration dictated by the notification mechanism even though the processor 560 and other components might shut down for conserving battery power. The LED may be programmed to remain on indefinitely until the user takes action to indicate the powered-on status of the device. The audio interface 574 is used to provide audible signals to and receive audible signals from the user. For example, in addition to being coupled to the audio transducer 525, the audio interface 574 may also be coupled to a microphone to receive audible input, such as to facilitate a telephone conversation. In accordance with embodiments of the present invention, the microphone may also serve as an audio sensor to facilitate control of notifications, as will be described below. The system 502 may further include a video interface 576 that enables an operation of an on-board camera 530 to record still images, video stream, and the like.

A mobile computing device 500 implementing the system 502 may have additional features or functionality. For example, the mobile computing device 500 may also include additional data storage devices (removable and/or non-removable) such as, magnetic disks, optical disks, or tape. Such additional storage is illustrated in FIG. 5B by the non-volatile storage area 568.

Data/information generated or captured by the mobile computing device 500 and stored via the system 502 may be stored locally on the mobile computing device 500, as described above, or the data may be stored on any number of storage media that may be accessed by the device via the radio 572 or via a wired connection between the mobile computing device 500 and a separate computing device associated with the mobile computing device 500, for example, a server computer in a distributed computing network, such as the Internet. As should be appreciated such data/information may be accessed via the mobile computing device 500 via the radio 572 or via a distributed computing network. Similarly, such data/information may be readily transferred between computing devices for storage and use according to well-known data/information transfer and storage means, including electronic mail and collaborative data/information sharing systems.

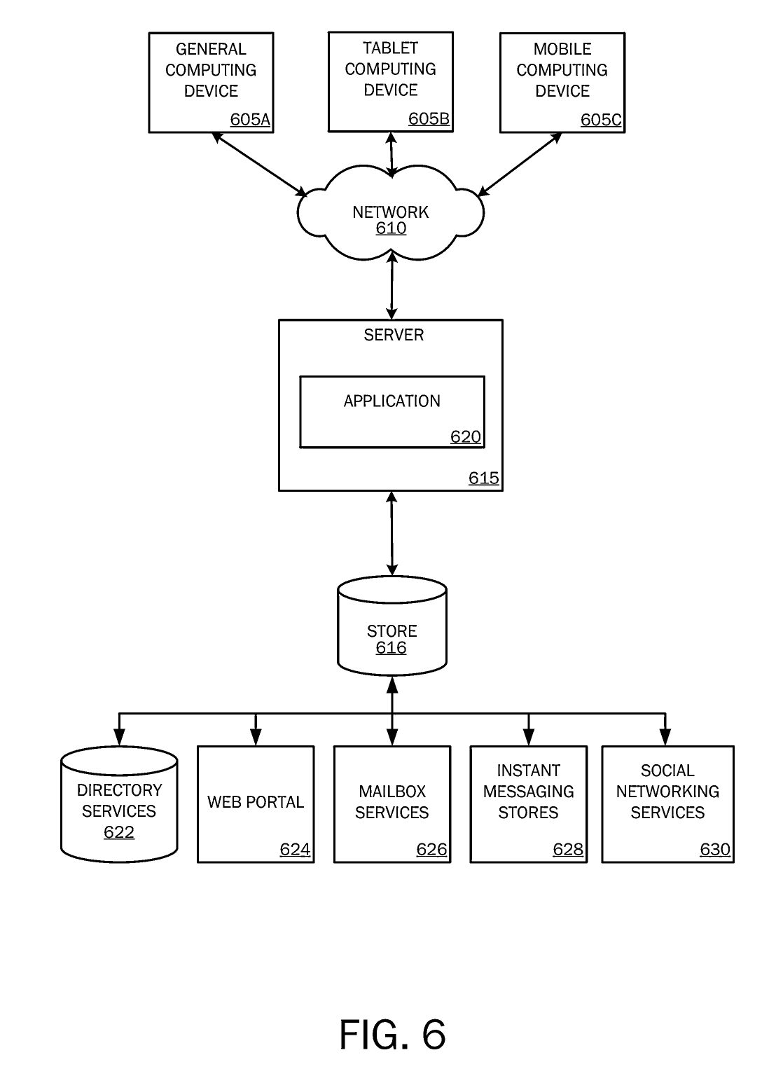

FIG. 6 illustrates one embodiment of the architecture of a system for providing the functionality described herein across components of a distributed computing environment. Content developed, interacted with, or edited in association with the applications described above may be stored in different communication channels or other storage types. For example, various documents may be stored using a directory service 622, a web portal 624, a mailbox service 626, an instant messaging store 628, or a social networking site 630. The application 620 (e.g., an electronic communication application) may use any of these types of systems or the like for providing the functionalities described herein across multiple workloads, as described herein. A server 615, 108 may provide the functionality to clients 605A-C and 104A-N. As one example, the server 615, 108 may be a web server providing the application functionality described herein over the web. The server 615, 108 may provide the application functionality over the web to clients 605A-C and 104A-N through a network 120, 610. By way of example, a client computing device 104A-N may be implemented and embodied in a personal computer 605A, a tablet computing device 605B and/or a mobile computing device 605C (e.g., a smart phone), or other computing device. Any of these embodiments of the client computing device may obtain content from the store 616.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

We claim:

1. A method for providing content view and use in an electronic communications user interface, comprising:
in a computer-generated electronic communications user interface, providing a communications pane in which is disposed one or more electronic communications;
in response to a selection of a content item attachment contained in one of the one or more electronic communications, animating into view in the computer-generated electronic communications user interface a display of an immersive view pane; and
automatically displaying in the immersive view pane a content item associated with the selected content item attachment for allowing a view of both the displayed content item and the one or more electronic communications in a single display of the electronic communications user interface.

2. The method of claim 1, wherein animating into view in the computer-generated electronic communications user interface a display of an immersive view pane includes sliding a display of the immersive view pane into the computer-generated electronic communications user interface while showing an animation of one or more components of the computer-generated electronic communications user interface being removed from view by being replaced by a display of the immersive view pane.

3. The method of claim 1, wherein animating into view in the computer-generated electronic communications user interface a display of an immersive view pane includes fading in a display of the immersive view pane into the computer-generated electronic communications user interface while showing an animation of one or more components of the computer-generated electronic communications user interface fading out of view while being replaced by a display of the immersive view pane.

4. The method of claim 1, in response to a selection for removing a display of the immersive view pane from the computer-generated electronic communications user interface, animating out of view in the computer-generated electronic communications user interface a display of the immersive view pane while showing an animation back into view in the computer-generated electronic communications user interface a display of any components of the computer-generated electronic communications user interface replaced by the immersive view pane while it is displayed in the computer-generated electronic communications user interface.

5. The method of claim 1, wherein if a given electronic communication disposed in the communications pane contains two or more content item attachments, providing an attachment well in the given electronic communication and disposing in the attachment well a selectable icon for each of the two or more content item attachments.

6. The method of claim 5, wherein the two or more content item attachments are disposed in a linear arrangement wherein each selectable icon for each of the two or more content item attachments are displayed in the attachment well successively.

7. The method of claim 5,
wherein in response to a selection of any of the selectable icons for any of the two or more content item attachments disposed in the attachment well, automatically displaying an associated content item in the immersive view pane; and
wherein in response to a selection of a different selectable icon disposed in the attachment well, automatically replacing a display of a presently displayed content item with a display of a content item associated with the different selectable icon.

8. The method of claim 5, wherein if the communications pane does not contain sufficient display space for displaying all selectable icons contained in the attachment well, displaying a truncated version of the attachment well and providing a navigation element for the truncated version of the attachment well for allowing navigation of the truncated version of the attachment well for displaying in the attachment well additional selectable icons not presently displayed in the truncated version of the attachment well.

9. The method of claim 5, further comprising displaying a navigation element in association with the immersive view pane for allowing navigation of content items associated with the two or more content item attachments contained in the attachment well, wherein in response to a selection of the navigation element, replacing a display of a first content item presently displayed in the immersive view pane with a display of a second content item associated with a next successive content item attachment disposed in the attachment well.

10. The method of claim 9, wherein displaying a navigation element in association with the immersive view pane includes displaying a navigation element on two opposing sides of the immersive view pane for selectively navigating to the right or to the left, wherein selectively navigating to the right or to the left causes a successive display of different content items associated with different content attachment icons disposed in the attachment well.

11. The method of claim 9, wherein displaying a navigation element in association with the immersive view pane includes displaying a filmstrip style navigation element in proximity to the displayed immersive view pane wherein the filmstrip style navigation element contains selectable icons corresponding to each content item attachment in the attachment well, and wherein selection of a given icon contained in the filmstrip style navigation element causes a display of a corresponding content item in the immersive view pane.

12. The method of claim 5, wherein a display of a content item in the immersive view pane may be replaced with a display of another content item corresponding to a next successive content item attachment disposed in the attachment well in response to a swipe across a surface of the immersive view pane.

13. The method of claim 12, wherein a swipe across a surface of the immersive view pane includes one of a right-to-left, left-to-right, top-to-bottom, or bottom-to-top swipe.

14. A method for providing content view and use in an electronic communications user interface, comprising:
in a computer-generated electronic communications user interface, providing a communications pane in which is disposed one or more electronic communications;
if a given electronic communication disposed in the communications pane contains two or more content item attachments, providing an attachment well in the given electronic communication and disposing in the attachment well a selectable icon for each of the two or more content item attachments; and
automatically displaying in the immersive view pane a content item associated with a content item associated with a content item attachment selected from the attachment well for allowing a view of both the displayed content item and the one or more electronic communications in a single display of the electronic communications user interface.

15. The method of claim 14, wherein the two or more content item attachments are disposed in a linear arrangement wherein each selectable icon for each of the two or more content item attachments are displayed in the attachment well successively.

16. The method of claim 14,
wherein in response to a selection of any of the selectable icons for any of the two or more content item attachments disposed in the attachment well, automatically displaying an associated content item in the immersive view pane; and
wherein in response to a selection of a different selectable icon disposed in the attachment well, automatically replacing a display of a presently displayed content item with a display of a content item associated with the different selectable icon.

17. The method of claim 14, wherein if the communications pane does not contain sufficient display space for displaying all selectable icons contained in the attachment well, displaying a truncated version of the attachment well and providing a navigation element for the truncated version of the attachment well for allowing navigation of the truncated version of the attachment well for displaying in the attachment well additional selectable icons not presently displayed in the truncated version of the attachment well.

18. The method of claim 14, further comprising displaying a navigation element in association with the immersive view pane for allowing navigation of content items associated with the two or more content item attachments contained in the attachment well, wherein in response to a selection of the navigation element, replacing a display of a first content item presently displayed in the immersive view pane with a display of a second content item associated with a next successive content item attachment disposed in the attachment well.

19. The method of claim 14, wherein automatically displaying in the immersive view pane a content item associated with a content item attachment selected from the attachment well includes animating into view in the computer-generated electronic communications user interface a display of an immersive view pane.

20. A computer-generated user interface, comprising:
a communications pane in which is disposed one or more electronic communications;
an attachment well displayed in association with an electronic communication having two or more content item attachments, the attachment well containing a selectable icon for each of the two or more content item attachments; and
an immersive view pane for displaying a content item corresponding to a selected content item attachment, the immersive view pane being animated into view in the computer-generated electronic communications user interface in response to a selection of a selectable icon contained in the attachment well;
wherein the communications pane and the immersive view pane are displayed in the computer-generated user interface to allow a viewing of both the communications pane and the immersive view pane in a single display of the computer-generated user interface.
